(19) United States
(12) Patent Application Publication
(10) Pub. No.: US 2015/0120615 A1
(43) Pub. Date: Apr. 30, 2015

(54) UNIFIED CATALOG MANAGEMENT OF BUSINESS PRODUCTS AND SERVICES

(71) Applicant: VERIZON PATENT AND LICENSING INC., Arlington, VA (US)

(72) Inventors: Chetan Gopal, Boston, MA (US); Swaminathan K. Natarajan, Chennai (IN); Dongxu Shan, Boston, MA (US); Jagan Mohan Gunalan, Burlington, MA (US); Dingli Zeng, Wellesley, MA (US); Gopan G. Menon, Chestnut Hill, MA (US); Joyce Alwin, Chennai (IN); Sivaramakrishnan Rajaraman, Chennai (IN); Subramanian Ramamoorthy, Chennai (IN); Sivabharathi Karunanidhi, Chennai (IN); Kenneth Richard Boehm, Colorado Springs, CO (US); Kristine Anne D. Jugo, Chantily, VA (US); Kimberly Eng Haberman, Concord, NC (US); Maria Liza D. Steel, Inverness, FL (US); Charles C. Chen, Boston, MA (US); Mingjun Zhang, Lexington, MA (US); Dinesh Agarwal, Irving, TX (US); Junke Xu, Plano, TX (US); Erin Arnold Clark, Cumming, GA (US); Krishnakumar N. Iyer, Cedar Rapids, IA (US); Scott G. Bleile, Cedar Rapids, IA (US); Scot Aaron Brown, Marion, IA (US); Faiz M. Hasanuzzaman, Bronx, NY (US); Ann Cecelia Walsh, Norwalk, CT (US); Paul Alapatt, Flower Mound, TX (US)

(73) Assignee: VERIZON PATENT AND LICENSING INC., Arlington, VA (US)

(21) Appl. No.: 14/067,846

(22) Filed: Oct. 30, 2013

(51) Int. Cl. G06Q 30/02

(52) U.S. Cl. CPC G06Q 30/0283
USPC 705/400

(57) ABSTRACT

A unified catalog of products and services is described. In one implementation, a method may include receiving an indication of products, offered by a business, that are to be provided to a customer of the business, where the products are defined in a catalog based on a hierarchical product model. The method further includes determining pricing information relating to the products, the determination of the pricing information including: identifying, based on the catalog, a plurality of pricing formulas associated with the plurality of products, and applying the pricing formulas to determine the pricing information.

### BACKGROUND

Large businesses, or other entities that offer a relatively complex set of products and services, may develop a complex set of business systems to handle the various aspects of selling the products/services, such as selecting a set of suitable products and services for a customer and generating a price quote for the customer. Different products and services can have different features relating to, for example, the functionality offered by the product/service, the availability of the product/service, customer selectable options that are available with the product/service, etc.

A business may maintain a number of different business systems that may be involved in the sale, maintenance, and fulfillment of the products and services offered by the business. The business systems, in performing their associated operations, may use a catalog of the products and services offered by the business.

### BRIEF DESCRIPTION OF THE DRAWINGS

FIG. 1 is a diagram conceptually illustrating an example of an overview of concepts described herein;

FIG. 2 is a diagram conceptually illustrating an example of relationships of elements used in the modeling of products;

FIG. 3 is a diagram illustrating an example of the hierarchical arrangement of products and solutions that may be stored by a product modeling component;

FIG. 4 is a diagram illustrating an example of the hierarchical arrangement of products, features, and specifications;

FIG. 5 is a diagram illustrating an example of conceptual components of a product modeling component;

FIGS. 6A and 6B are diagrams illustrating particular examples of rules applied to products in a catalog system;

FIGS. 7A and 7B are diagrams illustrating example data structures that may relate to the pricing of products;

FIG. 8 is a flow chart illustrating an example process that may be performed as part of the configuration and use of a catalog system; and

FIG. 9 is a diagram of example components of a device.

### DETAILED DESCRIPTION OF PREFERRED EMBODIMENTS

The following detailed description refers to the accompanying drawings. The same reference numbers in different drawings may identify the same or similar elements.

Aspects described herein will be described in relation to products and services that are provided by a business. For clarity, the term products, as used herein, may refer to products and/or services provided by a business.

Techniques described herein may provide for a unified catalog of products for a business. The products in the catalog may be modeled through a hierarchical model and using a standardized interface that allows the products to be automatically accessed and priced in a consistent manner. Rules that define limitations or compatibilities between products in the catalog may be defined and enforced. A pricing engine, relating to the products in the catalog, may determine prices for combinations of products in the catalog.

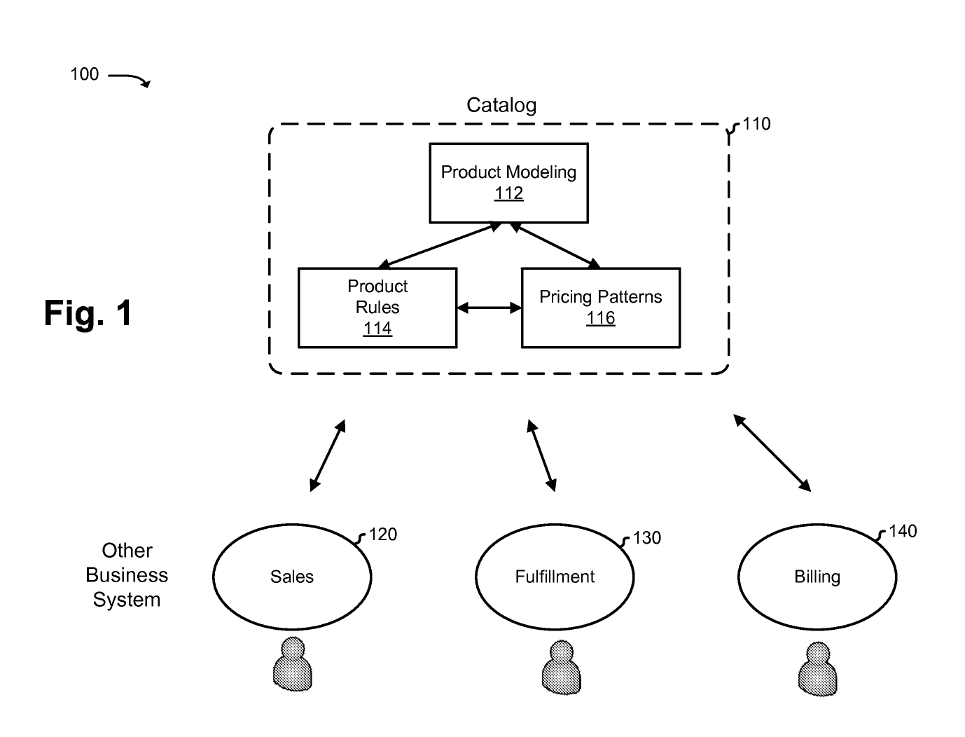

FIG. 1 is a diagram conceptually illustrating an example of an overview of concepts described herein. A set of business systems 100, which may correspond to business systems that are used in the sale and fulfillment of products, are illustrated in FIG. 1. The illustrated set of business systems include: catalog system 110, sales system 120, fulfillment system 130, and billing system 140.

Each of business systems 110-140 may represent one or more servers or processes that are used in the sale and fulfillment of products by a particular business. For example, business systems 110-140 may each include a set of custom applications, off-the-shelf applications, and/or business logic/rules that may be used by the particular business.

Catalog system 110 may include a centralized catalog of products offered by the business. The products may be modeled using a standardized interface that allows the products to be automatically accessed and priced in a consistent manner and in which limitations on particular products, such as product dependencies and exclusions, can be automatically taken into account. Because of the standardized interface used by catalog system 140, other business systems, such as business systems 120-140, may be able to automatically interact with catalog system 110.

Catalog system 110 may include a number of components, such as product modeling component 112, product rules component 114, and pricing patterns component 116. Product modeling component 112 may store a model for each of the products offered by the business. The models may include hierarchical models, such that certain products may be defined based on other products. For example, certain products may be modeled by product modeling component 112 as a “solution” that is defined by a number of more basic products. For example, a business may offer a product that provides private wide area network (WAN) services for a customer. The WAN product may include a number of other networking products, such as a service relating to reserved network links in a backbone network and a service relating to customer edge network links.

Product rules component 114 may maintain rules relating to the interaction, compatibility, and/or availability of products maintained by product modeling component 112. For example, a solution feature availability rule type may be used, for certain products, which when used in a particular solution, may only have a subset of the total number of available features of the product. Other rule types may include rules relating to products that are mutually exclusive with one another (e.g., products that cannot be used together) or rules relating to products that are dependent on one another (e.g., certain dependent products can only be included in a solution when corresponding base products are in the solution).

Pricing patterns component 116 may maintain one or more pricing processes that may be used to determine prices for one or more products or solutions that may be purchased by customers. In one implementation, products may be priced based on features of the product, such as features specified in product models component 112. Pricing patterns component 116 may include logic to, in addition to calculating prices, automatically generate a description corresponding to a pricing process.

Product modeling component 112, product rules component 114, and pricing patterns component 116, of catalog system 110, may be accessed by other business systems. For example, these components may be accessed by business systems used in the sale and fulfillment of products, such as business systems 120-140.

Sales system 120 may include logic to implement customer relationship management software to help model a business's interaction with current and future customers. Fulfillment system 130 may include logic to schedule and manage fulfillment (e.g., provisioning) of the products corresponding to a particular sale. Certain activities of fulfillment system 130 may be handled automatically by fulfillment system 130. For example, network elements may be automatically configured to support certain networking services. Billing system 140 may include logic to implement billing associated with products being provided to a customer. For example, depending on the terms of the contract relating to the sale, billing system 140 may track payments made by the customer, generate invoices for the customer, and perform other billing-related activities that are related to the sale.

Business systems 120-140, in the processes of performing business related activities, may interact with catalog system 110. For example, a salesperson, through sales system 120, may obtain a list of products, from catalog system 110 (e.g., via product modeling component 112 and product rules component 114), that may be relevant to a potential customer. The salesperson may also obtain pricing information through catalog system 110 (e.g., via pricing patterns component 116). When the customer and the salesperson agree on a sale of products, sales system 120 may forward an indication of the sale to fulfillment system 130, which may also use catalog system 110, in the fulfillment of the products. For example, in the context of products that correspond to network services, fulfillment system 130 may determine, based on catalog system 110, features relating to the products and may then use the features to automatically provision the network services. Billing system 140 may similarly use catalog system 110, to obtain information about various products, that may be used in the billing process.

Although the term “business” is used herein to refer to an entity that operates business system 100, in general, “business” may refer to any entity that provides products using a number of systems.

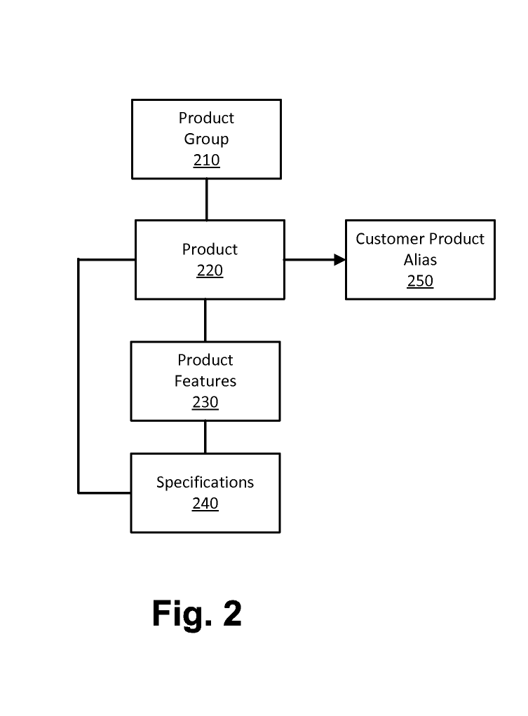

As previously mentioned, products in catalog system 110 may be modeled using a hierarchical modeling technique. The product models may be stored by product modeling component 112. FIG. 2 is a diagram conceptually illustrating an example of relationships of elements used in the modeling of products by product modeling component 112. As illustrated, a model of a particular product, as modeled by product modeling component 112, may include product group 210, product 220, product features 230, specifications 240, and customer product alias 250.

Product group 210 may include information, in a model of a product, that defines a logical group (e.g., a product category or business segment) that is applicable to a product. Each product group may be include one or more products. For example, in the context of a business that provides telecommunications products and services, a product group 110 may include the group “networking services.” A number of products or solutions, associated with networking services provided by the company, may be included in this group. For example, the products “managed WAN” and “managed local area network (LAN)” may be included in this group.

Product 220 may define a product or service offered by the business. A product can stand alone (e.g., may be sold by itself) or may need to be provided with other products. Product 220 may include the name of the product and/or additional descriptive features relating to the product. Each product 220, in product modeling component 112, may include product features 230 and specifications 240. Product feature 130 may include information indicating the features of a particular product. Features of a particular product may include, for example, one or more predefined feature codes and/or text that indicate the functionality of the product. For example, a private Internet Protocol (PIP) product may include with features “PIP port” and “Class of Service.” As another example, a “Secure Gateway” product may include the features “Encryption” and “Universal Port.” Specifications 240 may be associated with a particular product 220 or product feature 230. For each product or product feature, specifications 240 may include one or more attribute-value pairs, in which an attribute may include an identifier (e.g., a parameter name) and an associated value. As an example, the feature “Encryption,” for the product “Secure Gateway,” may include the attribute “Type of Encryption,” which may be associated with a value indicating the encryption technology and/or protocol that is to be used as part of the encryption performed by the “Secure Gateway” product.

Certain products may be rebranded or renamed to customer specific labels and/or descriptions. Customer product alias 250 may include information, relating to a particular product, that defines whether the particular product has been rebranded and information relating to the rebranding. Customer product alias 250 may effectively extend the product name associated with product 220.

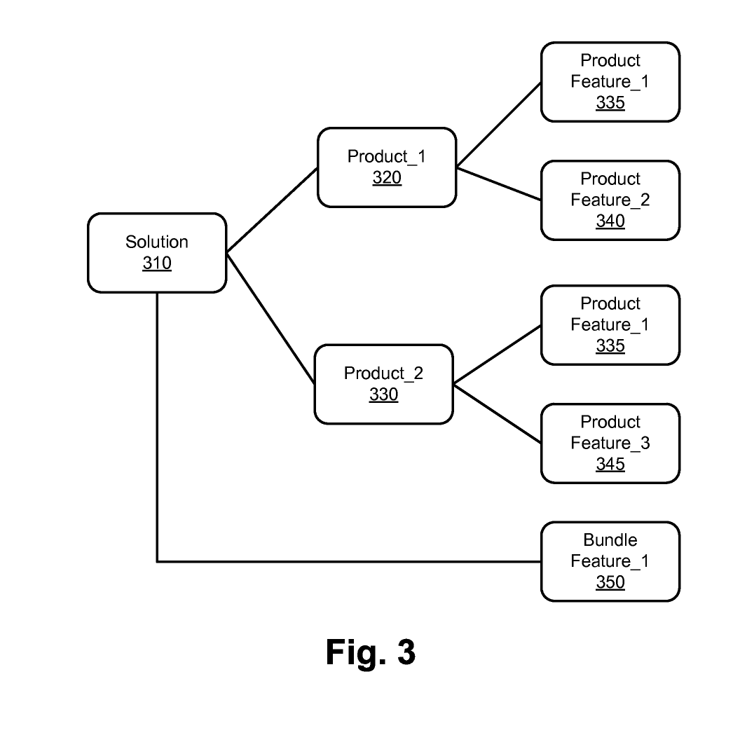

FIG. 3 is a diagram illustrating an example of the hierarchical arrangement of products and solutions that may be stored by product modeling component 112. As illustrated, a number of products (e.g., Product_{—}1 320 and Product_{—}2 330), which may each correspond to a product 220 (FIG. 2), may be associated with a solution 310. Solution 310 may include a composition of a set of products. Solutions may be designed and/or created to satisfy the need of a particular customer. Alternatively or additionally, a solution may be designed and/or created to offer as a generic solution to any potential customer.

Product_{—}1 320 and product_{—}2 330 may each be associated with product features 230. As illustrated, product_{—}1 320 is associated with product feature_{—}1 335 and product feature_{—}2 340. Similarly, product_{—}2 330 is associated with product feature_{—}1 335 and product feature_{—}3 345. A feature, such as product feature_{—}1 335, may be associated multiple products. Additionally, in some implementations, product features, instead of applying directly to a product, may apply to a solution. As illustrated in FIG. 3, bundle feature_{—}1 350 may be a feature that is directly associated with solution 310. Although not shown in FIG. 3, each feature 335-350, and/or products 320-330, may also be associated with specifications 240 (e.g., attribute-value pairs).

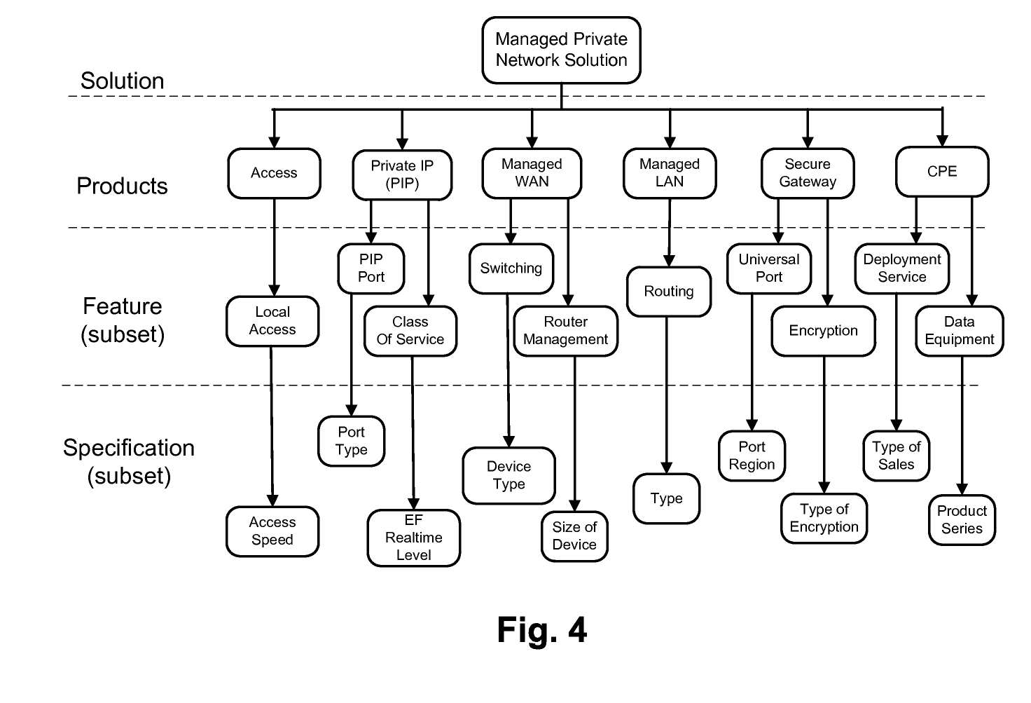

FIG. 4 is a diagram illustrating an example of the hierarchical arrangement of products, features, and specifications, for a particular solution. In the example of FIG. 4, products corresponding to a particular example solution, relating to products of a telecommunications business, are illustrated.

As shown in FIG. 4, a solution “Managed Private Network Solution,” may include a number of products. The solution may relate to private networks that are provided to customers. The solution may be associated with a number of products, which may include features and specifications. The products, features, and specifications may be customized for each particular customer. For example, a customer purchasing the “Managed Private Network Solution” may choose only certain products in the solution and may choose certain features and specifications (e.g., certain values for the attribute value pairs) that are desired by the customer.

The solution “Managed Private Network Solution” may include the products: “Access,” “PIP,” “Managed WAN,” “Managed LAN,” “Secure Gateway,” and “Customer Premise Equipment (CPE).” The product “Access” may relate to the access products needed to connect the customer premises. Access may include features such as “local access,” which may be associated with an attribute-value pair indicating the access speed that is ordered by the customer. The product “PIP” may be associated with the features “PIP port” (e.g., a feature describing the port at which the PIP is associated) and “Class of Service” (e.g., a feature describing the quality of service associated with the PIP). As shown, the feature “PIP Port” may be associated with the attribute-value pair “Port Type” and the feature “Class of Service” may be associated with the attribute-value pair “EF Realtime Level.”

As is further shown in FIG. 4, the product “Managed WAN” may be associated with the features “Switching” and “Router Management,” which may be associated with the specifications “Device Type” and “Size of Device,” respectively. The product “Managed LAN” may be associated with the feature “Routing” and the attribute-value pair “Type.” The product “Secure Gateway” may be associated with the features “Universal Port” and “Encryption,” which may be associated with the respective attribute-value pairs “Port Region” and “Type of Encryption.” The product “CPE” may be associated with the features “Deployment Service” and “Data Equipment,” which may be associated with the attribute-value pairs “Type of Sales” and “Product Series,” respectively.

As previously mentioned, product rules component 114 may maintain rules relating to the interaction, compatibility, and/or availability of products maintained by product modeling component 112. For example, certain products, stored by product modeling component 112, may not be compatible with other products, may be mutually exclusive with some products, may be dependent on other products, etc. Business systems 120-140 may use product rules component 114 as part of the sales process, product fulfillment process, and/or billing process.

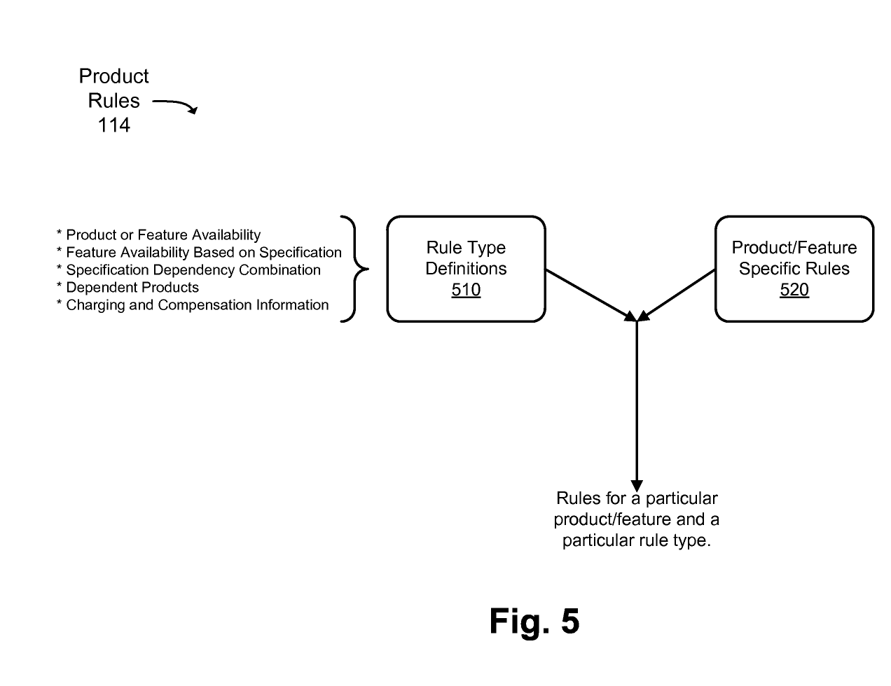

FIG. 5 is a diagram illustrating an example of conceptual components of product modeling component 112. Product rules component 1142 may include rule type definitions 510 and product/feature specific rules 520. Rules stored by product rules component 114 may be specified, by rule type definitions 510, as a set of rule types. The rule types may support rules relating to, for example: availability of products and features; dependency combinations relating to products; country-legal entity information; product country availability; solution and product-country availability, mutually exclusive products; dependent products, and/or charging and compensation. In one implementation, and as particularly illustrated in FIG. 5, the rule types, defined by rule type definitions 510, may include rules relating to: (1) product or feature availability, (2) feature availability based on specification, (3) specification dependency combinations, (4) dependent products, and (5) charging and compensation information.

Product/feature specific rules 520 may store the rule information relating to the products and features. In one implementation, product/feature specific rules 520 may include a matrix information table and a translation table. The matrix information table may include a set of generic columns along with a set of generic product core identifiers. The translation table may include mapping information that identifies the products/features corresponding to the columns in the matrix information table. Consuming systems may use the data in both tables, as well as the rule types in rule type definitions 510, to evaluate a rule and retrieve the relevant data for the rule and a product (or a rule and a product/feature combination).

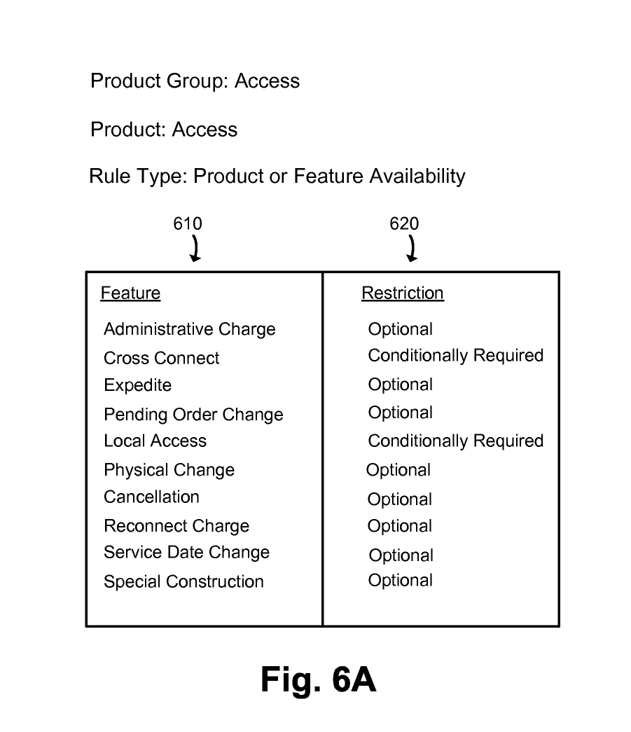

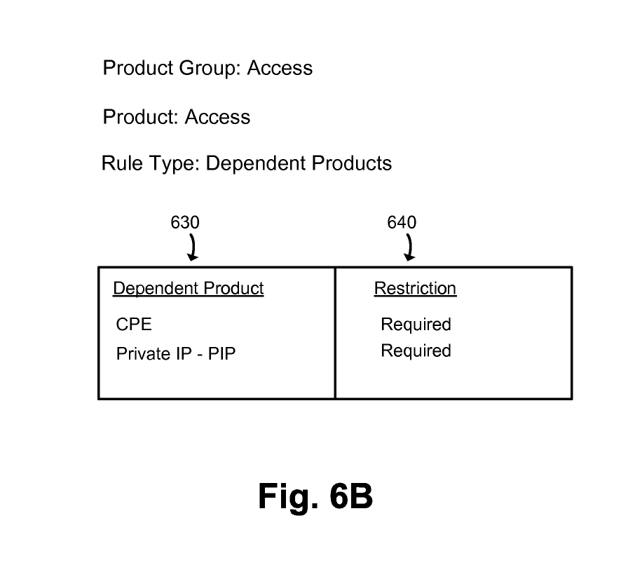

FIGS. 6A and 6B are diagrams illustrating particular examples of rule data that may be retrieved, from product rules component 114, for example products and rule types. The rule data may be retrieved programmatically, such as by business systems 120-140, and/or may be provided in a graphical interface that is presented to a user.

As illustrated in FIG. 6A, the product may be “Access” (e.g., a product relating to network access and included in the product group “Access”) and the rule type may be the rule type “Product or Feature Availability.” A number of features 610 may be retrieved for this product and rule type. In this example, the rule type may relate to restrictions 620 on the availability of each feature and may be one of optional (the feature may be selected or not selected by the customer and/or salesperson), required (the feature must be included as part of the product), or conditionally required (subject to other factors, the feature may be required).

FIG. 6B is a diagram illustrating an example of rule data for the product “Access” and the rule type “Dependent Products.” The dependent products, for a particular product, may refer to the products that must be bundled with the main product. A number of dependent products 630 may be retrieved for this product and rule type. In this example, the dependent products are illustrated as the products “CPE” and “Provider IP-PIP.” A type of dependency 640 is also illustrated for each dependent product. In the example, the dependent restriction is illustrated as “required,” indicating that dependent products 630 must be included in the main product.

As previously mentioned, pricing patterns component 116 may store one or more pricing processes that may be used to determine prices for one or more products or solutions that may be purchased by customers. In one implementation, each feature in product modeling component 112 may be associated with a pricing pattern, where a pricing pattern may include a formula that is applied to the feature. In this manner, complex pricing strategies can be automatically applied to determine prices, that are to be invoiced to customers, for combinations of products.

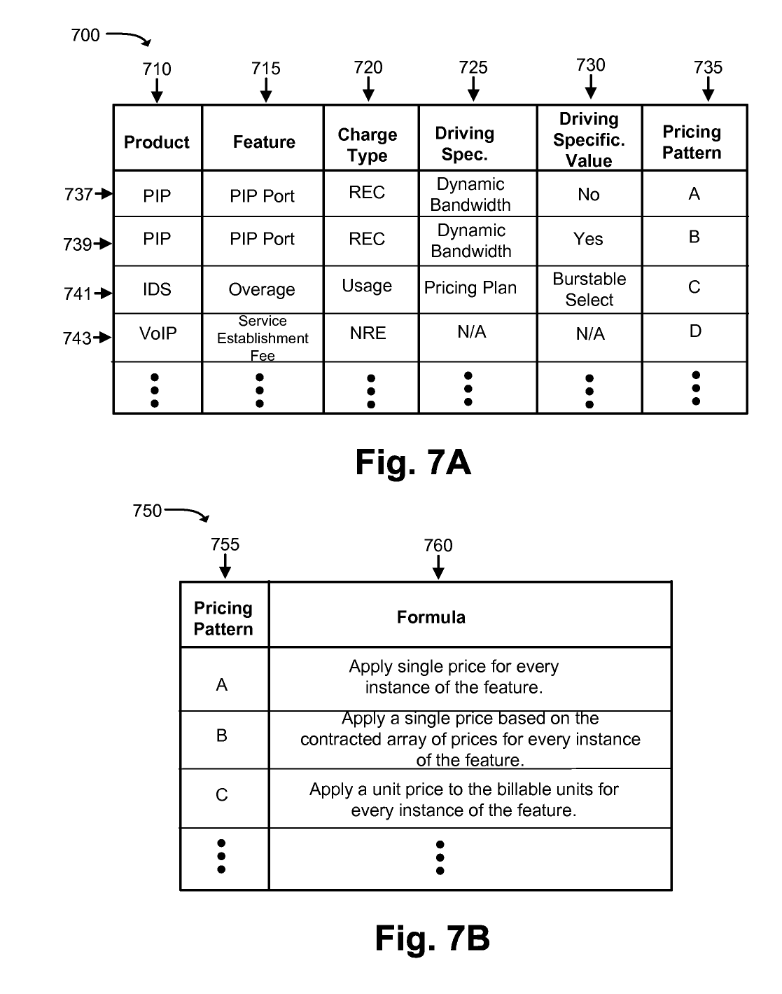

FIGS. 7A and 7B are diagrams illustrating example data structures 700 and 750, such as data structures that may be maintained by pricing patterns component 116. Data structure 700 may identify the pricing patterns to use for particular products/features. Data structure 750 may include a definition (formula) of a pricing process for each pricing pattern. Each of data structures 700 and 750 may include a number of fields. In alternative possible implementations, different, fewer, or additional fields may be implemented.

As illustrated in FIG. 7A, data structure 700 may include the fields: product field 710, feature field 715, charge type field 720, driving specification (spec.) field 725, driving specification (spec.) value field 730, and pricing pattern field 735. Product field 710 and feature field 715 may together include an identification of a particular feature of a particular product (e.g., such as a product feature 230 of a product 220) stored by product modeling component 112. Charge type field 720 may include a value indicating how the particular product/feature is to be charged. For example, the customer may be charged on a recurring (REC) basis (e.g., once monthly), based on usage of a particular product (e.g., based on the number of hours used or based on bandwidth used), as a non-recurring (e.g., one-time) fee (NRE), or based on another charging rule type. Driving specification field 725 may indicate the specification 240 (or multiple specifications) that are used to determine (“drive”) the charge amount for the product/feature. Driving specification value field 730 may further define how driving specification field 725 is to be used for a particular pricing pattern. Pricing pattern field 735 may identify the pricing process (formula) that applies to the particular entry in data structure 700 (e.g., to the particular product/feature combination).

Four example entries are illustrated in data structure 700. The first entry, entry 737, is associated with the product “PIP” and the feature “PIP Port.” The charge type is indicated as recurring (REC) (e.g., a recurring monthly charge) and includes an identification of the driving specification (dynamic bandwidth) and a value for this particular driving specification (No). The applicable pricing pattern is identified as pricing pattern “A.” The second entry in data structure 700, entry 739, may be similar to entry 737. That is, entry 739 may correspond to the product “PIP” and feature “PIP Port,” and the charge type is recurring. The driving specification is also “dynamic bandwidth.” In contrast to entry 737, for entry 739, the pricing pattern “B” is applied when the value of the driving specification is “Yes.” Thus, entry 737 and 739 may represent pricing patterns for the product and feature combination of “PIP/PIP Port,” and which collectively indicate that pricing pattern “A” is to be used when dynamic bandwidth is not used by the customer and pricing pattern B is to be used when dynamic bandwidth is used by the customer.

The third entry, entry 741, in data structure 700, may be associated with the product “IDS” and the feature “Overage.” The charge type is indicated as usage (e.g., the charge is based on an amount of use of a particular resource such as bandwidth). The driving specification is indicated as the specification “Pricing Plan,” the value for the driving specification is indicated as “Burstable Select,” and the pricing pattern is indicated as pattern “C.” Thus, for entry 741, the pricing formula corresponding to pricing pattern “C” will be used to charge for the product/feature “IDS/Overage” when the value of the specification “Pricing Plan” for this product/feature is set to “Burstable Select.”

The fourth entry, entry 743, in data structure 700, may be associated with the product “VoIP” and the feature “Service Establishment Fee.” The charge type is indicated as non-recurring (NRE), which may correspond to a one-time charge (e.g., when the product is first installed). For this product/feature, driving specification and the driving specification value are set to N/A, which may indicate that specifications 240 for this product/feature are not relevant to charging for the product/feature. The pricing pattern is indicated as pricing pattern “D.”

As mentioned, data structure 750 may include a definition of a pricing process for each pricing pattern. Data structure 750 may include a number of fields, including: pricing pattern field 755 and formula field 760. Pricing pattern field 755 may correspond to pricing pattern field 735 in data structure 700 and may be used to correlate the pricing processes in data structures 700 and 750. Formula field 760 may indicate the pricing formula for the particular pricing pattern. For example, as illustrated: for pricing pattern A, the formula may indicate that a single price is to be applied for every instance of the feature; for pricing pattern B, the formula may indicate that a single price is to be applied based on a contracted array of prices for every instance of the feature; and for pricing pattern C, the formula may indicate that a unit price is to be applied to the billable units for every instance of the feature.

In some implementations, formula field 760, in data structure 750, may be divided into a human readable (e.g., “English”) version of the formula, which may be presented to the customer or to workers associated with the business, and a symbolic (e.g., “Math”) version of the formula which may be used by pricing patterns component 116 when automatically calculating prices.

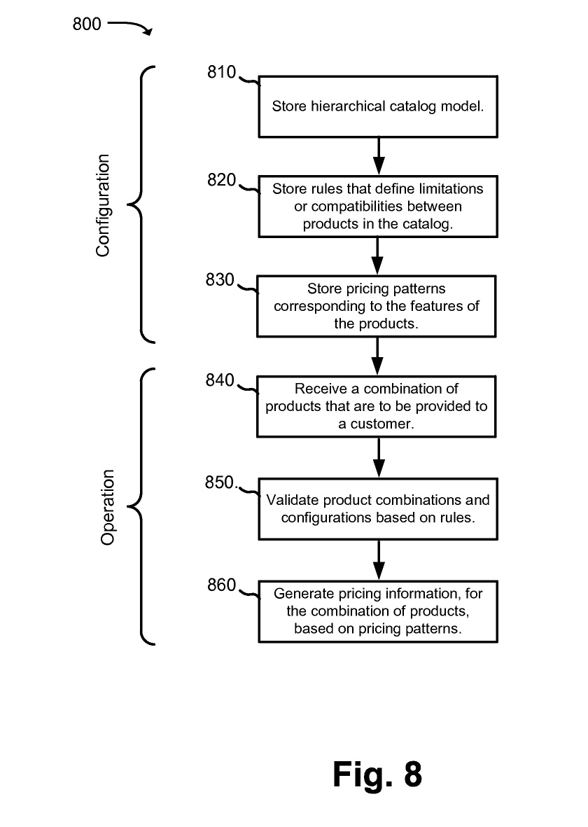

FIG. 8 is a flow chart illustrating an example process 800 that may be performed as part of the configuration and use of catalog system 110. Process 800 may include a configuration portion (blocks 810-830) and an operation portion (blocks 840-860). The configuration portion may relate to the establishment of catalog system 110, such as through the creation and/or definition of product modeling component 112, product rules component 114, and pricing patterns component 116.

As illustrated, process 800 may include storing a hierarchical catalog model (block 810). As discussed previously with respect to product modeling component 112, the product may be modeled as a product that includes one or more product features and one or more specifications (e.g., attribute-value pairs). Products and solutions (e.g., a collection of products) may be hierarchically defined based on other products.

Process 800 may further include storing rules that define limitations or compatibilities between products in the catalog (block 820). As previously mentioned, the rules may be defined based on a type of rule, such as rules relating to: the availability of products and features; dependency combinations relating to the products; country-legal entity information; product country availability; solution and product-country availability, mutually exclusive products; dependent products, and/or charging and compensation.

Process 800 may further include storing pricing patterns corresponding to the features of the products (block 830). The pricing patterns may correspond to one or more pricing processes that may be used to determine prices for one or more products or solutions that may be purchased by customers. In one implementation, each feature in product modeling component 112 may be associated with a pricing pattern, where a pricing pattern may include a formula that is applied to the feature.

Process 800 may further include receiving a combination of products that are to be provided to a customer (block 840). In one implementation, the customer may purchase a predefined solution that includes a number of products in product modeling component 112. The features and specifications, corresponding to the purchase products, may be customized for the customer. For example, for a sale of products corresponding to network services, the bandwidth, encryption techniques, a degree to which the network equipment is managed for the customer, and/or other features and specifications may be customized (e.g., by a salesperson interacting with the customer). The products that are to be provided to the customer may be determined through interaction with product modeling component 112.

Process 800 may further include validating the combination of products, and configurations of the products, based on the rules (block 850). For example, a salesperson that is on location at a customer premises may work with the customer to determine a combination of products that is desirable to the customer. The salesperson may submit the potential combination of products to product rules component 114 to obtain an indication of whether the chosen products, features, and specifications are compatible. For example, product rules component 114 may determine that: certain products are dependent on other products and thus cannot be purchased alone, certain products are not currently available, certain products are not eligible to be purchased in the jurisdiction of the customer's premise, certain products selected by the customer are mutually exclusive of one another, and/or other rule determinations.

The application of the rules maintained by product rules component 114 may alternatively or additionally be used by business systems other than those involved in the initial sale of products. For example, fulfillment system 130 and billing system 140 may additionally access product rules component 114 to determine inter-product limitations or compatibilities that fulfillment and/or billing.

Process 800 may further include generating pricing information, for the combination of products, based on the pricing patterns (block 860). For example, each of the features, corresponding to the combination of products, may be associated with a pricing pattern in pricing patterns component 116. The pricing pattern may be used to determine a price for the feature, and the prices of each of the features may be itemized to obtain an invoice associated with the combination of products. Alternatively or additionally, business systems 120-140 may use pricing patterns component 116 to perform other operations. For example, a salesperson, using sales system 120, may access pricing patterns component 116 to obtain preliminary price quotes that may be used when negotiating a final price with the customer.

In one implementation, changes to catalog system 110, such as changes to the product models stored by product modeling component 112, may be performed by the business based on a collaborative process in which proposed changes to catalog system 110 may be aggregated, reviewed, and deployed together in a batch. A worker, of the business, who wishes to modify data in catalog system 110 may initiate a workflow to implement the changes. The changes may be communicated to other designated workers that may vote on and/or propose modifications to the change.

Catalog system 110 may be a distributed system in which portions or copies of product modeling component 112, product rules component 114, and/or pricing patterns component 116 may be stored by multiple, possibly geographically distributed, information technology systems. In some implementations, a standardized distribution of catalog data, to the multiple information technology systems, may be used. For example, changes to the data of catalog system 110 may be distributed, via email, the secure file transfer protocol (SFTP), or another mechanism, to the information technology systems. The changes may be distributed as a text (human readable) file, which may allow workers associated with the receiving information technology systems to view the changes. In some implementations, the changes may be automatically incorporated by the receiving information technology systems.

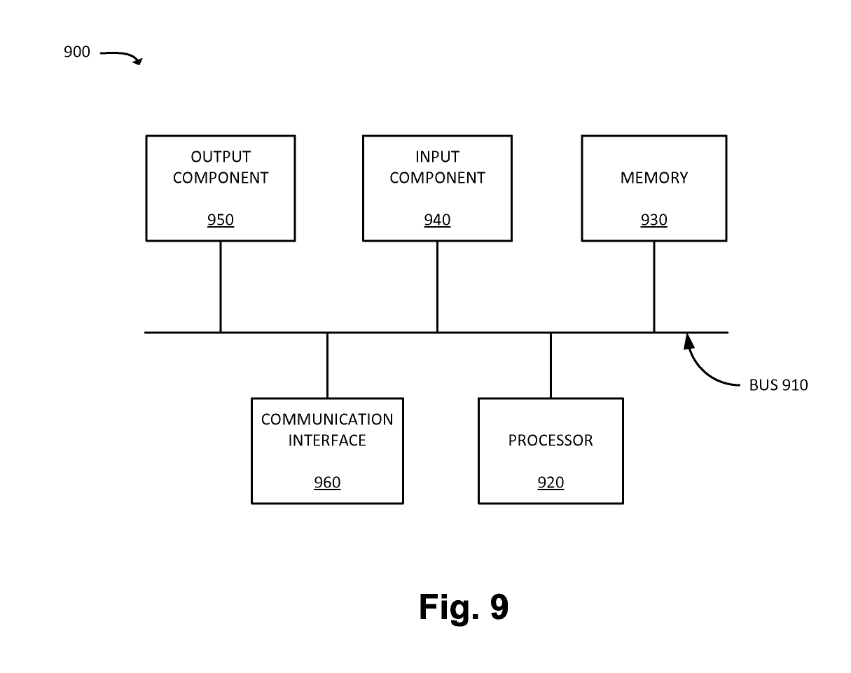

FIG. 9 is a diagram of example components of a device 900. Each of the devices illustrated in FIGS. 1 and 2 may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while series of blocks have been described with regard to FIG. 8, the order of the blocks may be modified in other implementations. Further, non-dependent blocks may be performed in parallel.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as “logic” that performs one or more functions. This logic may include hardware, such as an ASIC or a FPGA, or a combination of hardware and software.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. A method implemented by one or more devices, the method comprising:
receiving, by the one or more devices, an indication of a plurality of products, offered by a business, that are to be provided to a customer of the business, each of the plurality of the products being defined in a catalog based on a hierarchical product model;
determining, by the one or more devices, pricing information relating to the plurality of products, the determination of the pricing information including:
identifying, based on the catalog, a plurality of pricing formulas associated with the plurality of products, and
applying the pricing formulas to determine the pricing information; and
outputting, by the one or more devices, the pricing information.

2. The method of claim 1, further comprising:
validating the plurality of products based on application of business rules to the plurality of products, the business rules defining at least required product dependencies and mutually exclusive products.

3. The method of claim 2, wherein the business rules further include rules defining availability of the plurality of products or availability of the plurality of products in particular jurisdictions.

4. The method of claim 1, wherein the catalog includes at least one predefined solution that includes a plurality of compatible products from the catalog.

5. The method of claim 1, wherein the plurality of products include products and services relating to network connectivity.

6. The method of claim 1, wherein the catalog includes, for a particular product in the catalog:
one or more features that indicate functionality for the particular product, and
one or more specifications that define the one or more features, wherein each of the specifications are defined as attribute-value pairs.

7. The method of claim 6, wherein the determination of the pricing information further includes:
identifying a plurality of features corresponding to the plurality of products; and
identifying, based on the plurality of features, the plurality of pricing formulas.

8. The method of claim 7, further comprising:
identifying a plurality of specifications that correspond to the plurality of features, wherein applying the plurality of pricing formulas includes using at least one of the plurality of specifications as an input parameter to the plurality of pricing formulas.

9. The method of claim 1, further comprising:
receiving a request, initiated by a first worker associated with the business, to modify a definition of one or more of the plurality of products in the catalog;
communicating the request to one or more other workers associated with the business; and
performing the modification to the definition of the one or more of the plurality of products in the catalog based on a vote from the first worker and the one or more other workers.

10. A catalog system comprising:
one or more computing devices to:
receive an indication of a plurality of products, offered by a business, that are to be provided to a customer of the business, each of the plurality of the products being defined in a catalog based on a hierarchical product model;
determine pricing information relating to the plurality of products, the determination of the pricing information including:
identifying, based on the catalog, a plurality of pricing formulas associated with the plurality of products, and
apply the pricing formulas to determine the pricing information; and
output the pricing information to one or more business systems.

11. The system of claim 10, wherein the one or more computing devices are further to:
validate the plurality of products based on application of business rules to the plurality of products, the business rules defining at least required product dependencies and mutually exclusive products.

12. The system of claim 11, wherein the business rules further include rules defining availability of the plurality of products or availability of the plurality of products in particular jurisdictions.

13. The system of claim 10, wherein the catalog includes at least one predefined solution that includes a plurality of compatible products from the catalog.

14. The system of claim 10, wherein the plurality of products include products and services relating to network connectivity.

15. The system of claim 10, wherein the catalog includes, for a particular product in the catalog:
one or more features that indicate functionality for the particular product, and
one or more specifications that define the one or more features, wherein each of the specifications are defined as attribute-value pairs.

16. The system of claim 15, wherein, when determining the pricing information, the one or more computing devices are further to:
identify a plurality of features corresponding to the plurality of products; and
identify, based on the plurality of features, a corresponding plurality of pricing formulas.

17. The system of claim 16, further comprising:
identifying a plurality of specifications that correspond to the plurality of features, wherein applying the pricing formulas includes using at least one of the plurality of specifications as an input parameter to the pricing formulas.

18. A method implemented by one or more devices, the method comprising:
storing, by the one or more devices, a catalog of a plurality of products, offered by a business, wherein the catalog is defined based on a hierarchical product model in which a particular product in the plurality of products in the catalog is modeled to include
features that indicate functionality for the particular product, and
specifications that define the one or more features, wherein each of the specifications are defined as attribute-value pairs;
validating, by the one or more devices, a set of the plurality of products based on application of business rules to the set of the plurality of products, the business rules defining at least required product dependencies and mutually exclusive products; and
determining, by the one or more devices, pricing information relating to the plurality of products, the determination of the pricing information including:
identifying, based on the catalog, a plurality of pricing formulas associated with the plurality of products, and
applying the pricing formulas to determine the pricing information.

19. The method of claim 18, wherein the business rules further include rules defining availability of the plurality of products or availability of the plurality of products in particular jurisdictions.

20. The method of claim 18, wherein the determination of the pricing information further includes:
identifying a plurality of features corresponding to the plurality of products; and
identifying, based on the plurality of features, a corresponding plurality of pricing formulas.
